(19) United States
(12) Patent Application Publication
(10) Pub. No.: US 2007/0286731 A1
(43) Pub. Date: Dec. 13, 2007

(54) Wind power plant

(76) Inventor: Joerg Dantlgraber, Lohr am Main (DE)

Correspondence Address: KENYON & KENYON LLP, ONE BROADWAY, NEW YORK, NY, 10004, US

(21) Appl. No.: 11/731,208

(22) Filed: Mar. 29, 2007

(30) Foreign Application Priority Data
Mar. 31, 2006 (DE) 10 2006 015 511.4

(51) Int. Cl. F03B 3/14

(52) U.S. Cl. 416/162

(57) ABSTRACT

A wind power plant having a device for adjusting the angle of pitch of the rotor blades situated on a hub, the rotor blades being able to be set via respectively at least one asynchronous motor in normal operation, and being able to be rotated into their safety position (feathered pitch) in emergency operation. The asynchronous motor is fed in emergency operation via a commutator driven by a DC motor from a DC source that is independent of the network.

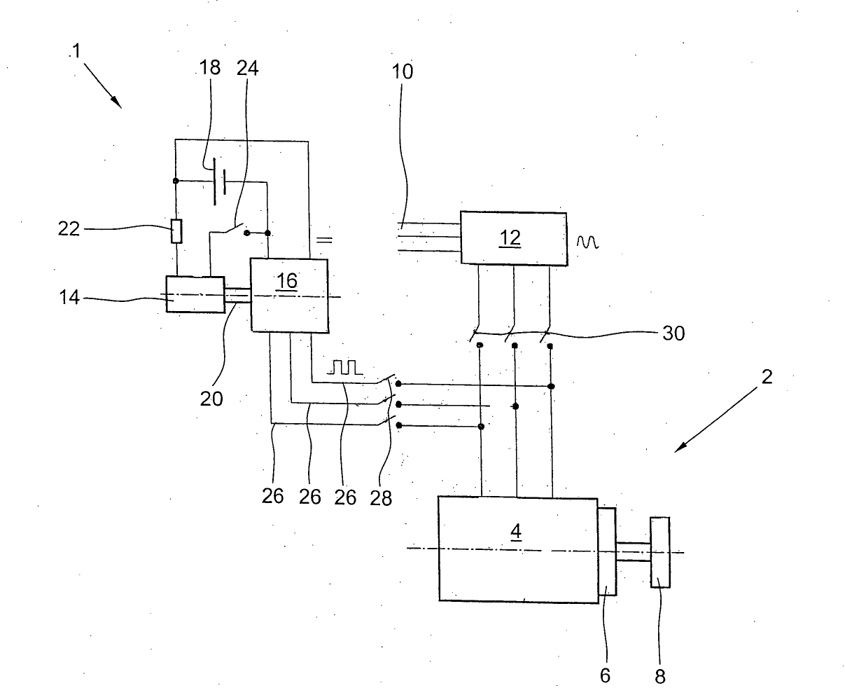

### FIELD OF THE INVENTION

The present invention relates to a wind power plant.

### BACKGROUND INFORMATION

In wind power plants, the flow energy of the wind over a rotor is converted to usable rotational energy. The angle of pitch of the rotor blades to the wind is set, for this purpose, via a mechanical blade adjustment mechanism as a function of the strength of the wind, in order to utilize the wind power in optimal fashion, and in order to put the rotor blades into their feathered pitch, that is, into a safety position in which the plant is braked aerodynamically (torque on main origin=0), in order to avoid overload damage to the wind power plant, caused by an inadmissibly high speed of the rotor. For safety reasons, each individual rotor blade has its own adjusting drive, so that a sufficient speed limitation is achieved even if one of the adjusting drives should fail.

If there is a failure in the power supply system, since it then has to be possible to put the rotor blades into their feathered pitch, an auxiliary power supply is assigned to the adjustment motors which are activated via electromagnetic switches (contactors) in case of malfunction. It is basically required that the blade angle adjustment system be designed electrically as simply as possible, and insensitive to malfunctions, since wind power plants are greatly exposed to the danger of lightning strikes, and electronic components react in a very sensitive manner to overvoltages, and are easily destroyed. For this reason, the use of electronic components is omitted as far as possible.

A wind power system is discussed, for example, in German patent document DE 297 22 109 U1, having a plurality of rotor blades to each of which is assigned one drive unit for adjusting the angle of pitch. In this design approach, the drive unit is made up of a DC motor that is electrically supplied by a battery. To do this, the battery is connected to the DC motor via an emergency shutoff switch or a centrifugal force switch, until the rotor blades are in their feathered pitch (storm setting) and an end switch is activated.

What is disadvantageous in such wind power plants is that the mechanically commutated DC motors are very maintenance-intensive because of collector wear, and have a limited service life at a relatively large space requirement. Because of process engineering reasons, it is often desirable to adjust the rotor blades dynamically under steady operating conditions, in dependence upon the position of the rotor. For this, DC motors are not suitable, because of their limited dynamics and their low service life. In addition, when DC motors are switched on, very high currents and torques are created. Therefore, both the electrical and the mechanical components have to be designed for this operating case.

In order to improve the performance of the blade adjustment, an exemplary embodiment of a wind power plant as in German patent document DE 100 09 472 C2 provides that the electric motors are developed as squirrel-cage rotors (asynchronous motors). In this design approach, the energy supply of the motors takes place via a permanent magnet generator assigned to the rotor shaft, which gathers the energy required for the blade adjustment from the rotational motion of the rotor. The rotating magnetic field of the three-phase current generated in the permanent magnet generator is interconnected with the squirrel-cage rotors and able to be switched in via a contactor in such a way that the squirrel-cage rotors rotate the rotor blades into their feathered pitch, in an emergency. This design approach does make possible an improved rotor adjustment, because of the high dynamics of asynchronous motors, but because of the generation of three-phase current, it calls for considerably increased expenditure when compared to permanent magnet generators.

### SUMMARY OF THE INVENTION

By contrast, the exemplary embodiment and/or the exemplary method of the present invention concerns a wind power plant having an improved rotor adjustment at minimum expenditure with respect to device technology.

This objective is attained by a wind force plant having the features described herein.

The wind power plant according to the exemplary embodiment and/or the exemplary method of the present invention has a device for adjusting the angle of pitch of the rotor blades positioned rotatably on a hub, the rotor blades being able to be set via an asynchronous motor in normal operation and being able to be rotated into their safety position (feathered pitch) in emergency operation. According to the exemplary embodiment and/or the exemplary method of the present invention, the asynchronous motor is fed in emergency operation, for instance, upon failure of the network voltage, via a commutator driven by a DC motor from a DC source that is independent of the network. By the rotation of the commutator, a pulsed alternating current is formed, from the direct current supplied by the DC source, which is sufficient for putting the rotor blades into their safety position.

In other words, the commutator interrupts the direct current of the network-independent direct current source in a regular sequence, and thereby generates a pulse-shaped alternating current or three-phase current for driving the asynchronous motor. The direct current motor can be dimensioned to be relatively small, in this instance, because no great force is required for operating the commutator. Since the three-phase current generation for the asynchronous motor takes place mechanically via the direct current motor and the commutator, the auxiliary power supply has no electronic components, so that the wind power plant according to the exemplary embodiment and/or the exemplary method of the present invention is insensitive to malfunctions and damage, for example, from overvoltages occurring because of a lightning strike. Even in case of power failure, the auxiliary power supply ensures a safe readjustment of the rotors into a feathered pitch.

According to one exemplary embodiment of the present invention, at least one electromagnetic switch (contactor) is situated between the commutator and the asynchronous motor, via which the commutator is able to be connected on the output side to the asynchronous motor for auxiliary power supply.

In normal operation, the asynchronous motor may be driven via a network connection having network voltage, and the electrical connection to the auxiliary power supply is interrupted by the electromagnetic switch.

The asynchronous motor may be connected to the network connection via a frequency converter. The frequency converter converts the 3-phase network voltage of fixed frequency and amplitude, that is present, into a 3-phase voltage having adjustable frequency and amplitude. For instance, a U/f frequency converter, which regulates the motor voltage and the frequency in a linear ratio, can be used, or a field-oriented frequency converter can be used which regulates torque and rotary speed at the same time, so that an accurate torque regulation and speed regulation is possible in the normal operation of the rotor blade adjustment.

It has been proven to be particularly advantageous if the asynchronous motor in emergency operation is separated via at least one electromagnetic switch from the frequency converter. The frequency converter is electrically decoupled thereby in emergency operation, and is protected from damage by, for example, a lightning strike.

In one exemplary embodiment of the present invention, the direct current motor is connected to the direct current source via a series resistor, and is able to be operated via a switch. In this instance, the series resistor is used to limit the speed of the direct current motor.

It has proven particularly advantageous if a battery or an accumulator is used as a direct current source.

The asynchronous motor may operate the rotor blades via a gearing, such as, for example, a planetary gearing. Thereby, even using relatively small, light asynchronous motors, the required high torques for the rotor adjustment can be mustered.

Advantageous further developments of the exemplary embodiment and/or the exemplary method of the present invention are also described herein.

In the following, the exemplary embodiment and/or the exemplary method of the present invention is explained in greater detail with the aid of an exemplary embodiment.

### BRIEF DESCRIPTION OF THE DRAWING

The FIGURE shows a schematic representation of an electrical circuit diagram of a wind power plant according to the exemplary embodiment and/or the exemplary method of the present invention.

### DETAILED DESCRIPTION

The FIGURE shows a schematic representation of a wind power plant 1 according to the exemplary embodiment and/or the exemplary method of the present invention, having a device 2 for adjusting the angle of pitch of the rotor blades (not shown) positioned rotatably on a hub. The angle of pitch of the rotor blades to the wind is able to be adjusted via blade adjustment mechanism 2, as a function of the wind force, in order to use the wind force in an optimum fashion, and to put the rotor blades into their safety position when the wind is too strong. In this way, overload damage in wind power plant 1, based on an inadmissibly high speed, is avoided. Blade adjustment mechanism 2 is made up essentially of an adjustment drive 4 which, in the exemplary embodiment shown, is executed as an asynchronous motor, and a gearing 6 preconnected to it. Thereby, even using relatively small, light asynchronous motors 4, the required high torques for the rotor adjustment can be mustered.

Asynchronous motor 4 is usually fastened to the rotor blade, and engages with a tooth construction on the rotor hub (not shown), via preconnected planetary gear 6 and a gear wheel 8. However, for safety reasons, each rotor blade is able to be adjusted via its own adjustment drive 4, so that even if there is a failure of one of adjustment drives 4, a sufficient speed limitation of the rotor can be achieved. In normal operation, asynchronous motor 4 is operated via a frequency converter 12 that is connected to a network connection 10. The frequency converter converts the 3-phase network voltage of fixed frequency and amplitude, that is present, into a 3-phase voltage having adjustable frequency and amplitude. For instance, a U/f frequency converter, which regulates the motor voltage and the frequency in a linear ratio can be used, or a field-oriented frequency converter can be used, which regulates torque and rotary speed at the same time, so that an accurate torque regulation and speed regulation is possible of the asynchronous motor in the normal operation of wind power plant 1.

According to the exemplary embodiment and/or the exemplary method of the present invention, asynchronous motor 4 is fed in emergency operation, for instance, upon failure of the network voltage, via a commutator 16 driven by a DC motor 14 from a DC source 18 that is independent of the network. To do this, DC motor 14 is coupled rotatably fixed to commutator 16 via a drive shaft 20. Electrically speaking, DC motor 14 is connected to DC source 18 via a series resistor 22, and is operable via a switch 24 provided in the battery circuit. In this instance, series resistor 22 is used for speed limitation of DC motor 14, during the operation of commutator 16. In the exemplary embodiment shown, a battery is used as the DC source. Commutator 16 is connected to battery 18 on the input side and is able to be connected on the output side to asynchronous motor 4 via three lines 26. For these connections, a triple electromagnetic switch 28, developed as a contactor, is situated between commutator 16 and asynchronous motor 4.

By rotation of commutator 16 using DC motor 14, a pulsed alternating current for operating asynchronous motor 4 is generated from the direct current supplied by battery 18, and this is sufficient to put the rotor blades into their safety position even when there is a failure in the network supply. In other words, commutator 16 interrupts the direct current of battery 18 in a regular sequence and thereby generates a pulse-form three-phase current for driving asynchronous motor 4, so that the emergency supply ensures a safe resetting of the rotor blades into their feathered pitch, even when there is a power failure. Since the three-phase current generation for asynchronous motor 4 takes place mechanically via direct current motor 14 and commutator 16, the auxiliary power supply has no electronic components, so that wind power plant 1 according to the exemplary embodiment and/or the exemplary method of the present invention is insensitive to malfunctions and damage, for example, from overvoltages occurring because of a lightning strike. In order to protect frequency converter 12 from damage in emergency operation, for instance, by a lightning strike, it is able to be electrically decoupled via a triple electromagnetic switch 30 that is developed as a contactor.

For the better understanding of wind power plant 1 according to the exemplary embodiment and/or the exemplary method of the present invention, its function will be briefly described below.

In the normal operation of wind power plant 1, asynchronous motor 4, provided for adjusting the rotor blades, is supplied by frequency converter 12 via closed contactor 30, the former being, in turn, fed via network connection 10 by the 3 phases of the network. Contactor 28, between commutator 16 and asynchronous motor 4 is open in normal operation, so that the emergency supply is decoupled. In emergency operation, for example during failure of the network supply, the asynchronous motor is supplied via the emergency supply. In order to prevent too fast a rotation of the rotor, and the danger of rotor fracture connected with it, an adjustment of the rotor blades into their safety position is carried out. To do this, contactor 30 between frequency converter 12 and asynchronous motor 4 is opened, and frequency converter 12 is thereby electrically decoupled, in order to protect it from damage, for instance, by a lightning strike.

In an additional step, contactor 28, that is open in normal operation between commutator 16 and asynchronous motor 4, is closed, so that the emergency power supply is connected to asynchronous motor 4. Furthermore, the battery circuit is closed via switch 24, and DC motor 14 is put in operation. DC motor 14 is fed by battery 18 via series resistor 22 that is used for speed limitation, and drives commutator 16 via drive shaft 20. The commutator is connected to battery 18 on its input side and to asynchronous motor 4 via contactor 28. Rotation of commutator 16 turns the DC current supplied by battery 18 into a pulsed alternating current that is sufficient to drive asynchronous motor 4, and thereby to put the respective rotor blade into the safety position, and to brake the rotor.

Wind power plant 1 according to the exemplary embodiment and/or the exemplary method of the present invention is not limited to described battery 18 as emergency source, but rather, any DC source known from the related art, especially an accumulator, can be used. It is essential to the exemplary embodiment and/or the exemplary method of the present invention that asynchronous motor 4 is fed during emergency operation from a network-independent DC source 18 via a commutator 16 driven by a DC motor 14, so that the rotor blades are safely able to be put into their feathered pitch when there is a failure in the network supply, and damage to wind power plant 1 because of too high a rotor speed is excluded.

A wind power plant 1 is described having a device 2 for adjusting the angle of pitch of the rotor blades positioned on a hub, the rotor blades being able to be set via respectively at least one asynchronous motor 4 in normal operation, and being able to be rotated into their safety position (feathered pitch) in emergency operation. According to the exemplary embodiment and/or the exemplary method of the present invention, asynchronous motor 4 is fed in emergency operation via a commutator 16 driven by a DC motor 14 from a DC source 18 that is independent of the network.

The list of reference numerals is as follows:

1 wind power plant;

2 blade adjustment device;

4 adjustment drive;

6 gearing;

8 gear wheel;

10 network connection;

12 frequency converter;

14 DC motor;

16 commutator;

18 DC source;

20 drive shaft;

22 series resistor;

24 switch;

26 line;

28 switch (contactor); and

30 switch (contactor).

What is claimed is:

1. A wind power plant comprising:
an adjusting device to adjust an angle of pitch of rotor blades situated on a hub, the rotor blades being settable via respectively at least one asynchronous motor in normal operation, and being rotatable into their safety position (feathered pitch) in emergency operation, wherein the at least one asynchronous motor is fed in emergency operation via a commutator driven by a DC motor from a DC source that is independent of a network.

2. The wind power plant of claim 1, wherein at least one electromagnetic switch is situated between the commutator and the asynchronous motor.

3. The wind power plant of claim 2, wherein, in normal operation, the asynchronous motor is driven using network voltage and the electrical connection to the emergency supply is interrupted by the electromagnetic switch.

4. The wind power plant of claim 3, wherein the asynchronous motor is connected to a network connection via a frequency converter.

5. The wind power plant of claim 4, wherein, in emergency operation, the asynchronous motor is electrically separated from the frequency converter via at least one electromagnetic switch.

6. The wind power plant of claim 1, wherein the DC motor is connected to the DC source via a series resistor.

7. The wind power plant of claim 1, wherein the DC motor is operable via a switch.

8. The wind power plant of claim 1, wherein the DC source is one of a battery and an accumulator.

9. The wind power plant of claim 8, wherein the asynchronous motor is connected to the rotor blades via a gearing.

10. The wind power plant of claim 8, wherein the asynchronous motor is connected to the rotor blades via a planetary gearing.
